(19) United States
(12) Patent Application Publication
(10) Pub. No.: US 2003/0210230 A1
(43) Pub. Date: Nov. 13, 2003

(54) Invisible beam pointer system

(76) Inventor: Richard C. Waters, Concord, MA (US)

Correspondence Address: Patent Department, Mitsubishi Electric Research Laboratories, Inc., 201 Broadway, Cambridge, MA, 02139, US

(21) Appl. No.: 10/142,032

(22) Filed: May 9, 2002

(51) Int. Cl. G09G 5/08

(52) U.S. Cl. 345/158

(57) ABSTRACT

An invisible beam pointer system is provided with one or more input images. A beam of invisible electro-magnetic radiation is activated and directed at a desired location of a display surface, while a sensor acquires a location of the beam on the display surface. Pixels in the input image, corresponding to the location, are then modified or annotated, to produce an output image that is projected on the display surface.

### FIELD OF THE INVENTION

This invention relates generally to input devices for display systems, and more generally to pointing devices and systems for human interaction with projected display systems.

### BACKGROUND OF THE INVENTION

It is natural to point at something when one is trying to convey information to others. Pointing at real-world objects, for example, whiteboards and projected images, is an often used aid during conversations, instructions, and collaborative discussions. Pointing can be direct when using fingers, sticks, and visible light beam pointers, or indirect when using touch pads, mice, or track-balls.

When the pointing is at a computer generated image, the act of pointing is frequently followed by the computer taking some action. For example, pointing and clicking a mouse can be used to select a displayed icon, a menu option, or a portion of displayed text.

Recently, laser pointers have become common during presentations. A conventional laser pointer typically includes a cylindrical body about the same size as a pen, a circuit for driving the laser, and a battery. The laser is activated by pressing a switch which causes a small visible beam of red light to be emitted.

During operation, the laser pointer is directed at the location about which the user wishes to convey information.

However, because the user is often far from the display screen, it is difficult to accurately direct the beam. In addition, a large distance amplifies any jitter while directing the beam. Also, because the beam has a very small cross-section, it is hard to see, particular when the room is brightly lit, or the item being illuminated by the laser pointer is highly textured or colored, which is true for all multi-color images. This is a particularly problem for laser pointers that use red light. It is not possible to use a laser pointer in outdoor settings, except perhaps at night. Thus, conventional visible light laser pointers are of limited use.

Therefore, it is desired to provide a pointer system that overcomes the problem of prior art pointing devices.

### SUMMARY OF THE INVENTION

An invisible beam pointer system is provided with one or more input images. The images can be generated by a computer or camera. A beam of invisible electro-magnetic radiation, for example, infra-red, is activated and directed at a desired location of a display surface.

A sensor acquires a location of the beam on the display surface. Pixels in the input image, corresponding to the location, are then modified or annotated, to produce an output image that is projected on the display surface. The annotation can be in the form of a cursor icon. The sensor can be integrated in a digital projector system.

### BRIEF DESCRIPTION OF THE DRAWINGS

FIG. 1 is a schematic diagram of an invisible beam pointer system according to the invention; and

FIG. 2 is a flow diagram of a method for operating the system of FIG. 1 according to the invention.

### DETAILED DESCRIPTION OF THE PREFERRED EMBODIMENT

System Structure

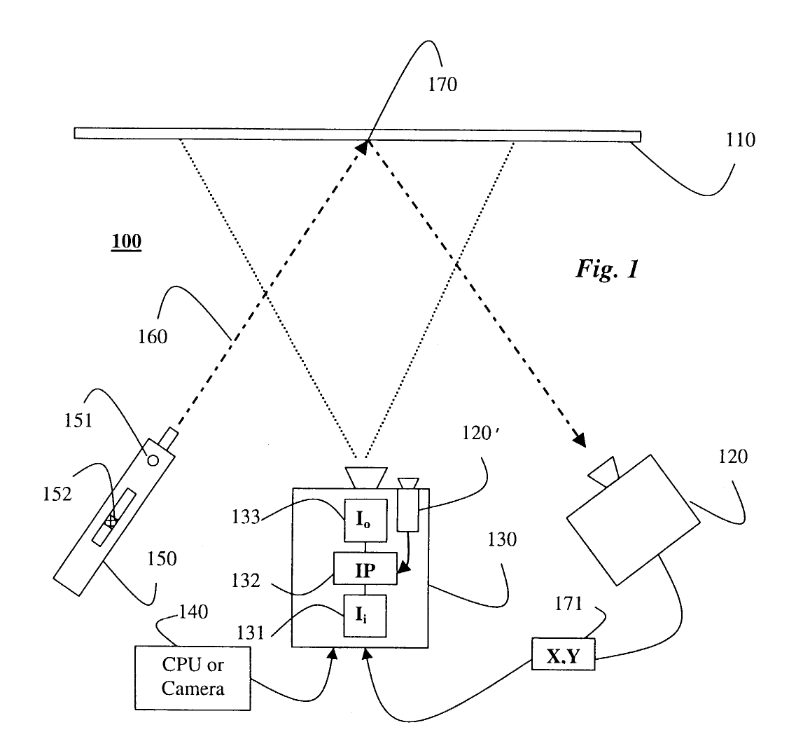

FIG. 1 shows an invisible beam pointer system 100 according to the invention. The system 100 includes a display surface 110, a sensor 120, a projector 130 coupled to the sensor 120, and an invisible beam pointer 150. The projector 130 can use DLP (Digital Light Processing) or LCD (Liquid Crystal Display) technologies, and the sensor 120 can use known CCD technologies. The projection mode can be front or rear. Alternatively, the display surface 110 can be a CRT or LCD screen. The sensor and projector are preferably pixel based. In a preferred embodiment, the sensor (120′) is integrated with the projector 130 as a single unit.

As a requirement of the invention, a beam 160 of electro-magnetic (EM) radiation emitted by the pointer 150 is invisible to the human eye. The invisible region of the electro-magnetic radiation has a wavelength greater than approximately 700 nanometers (nm) (infra-red) or less than approximately 400 nm (ultra-violet). For example, if the displayed image is one meter square with a resolution of 1000×1000 pixels, then the wavelength of the electro-magnetic ration should be smaller than approximately one millimeter for a single pixel resolution, although this is not necessary. Thus, the beam could be a high-frequency RF signal. In the preferred embodiment, an infra-red EM beam emitter, and CCD or CMOS sensors are used, i.e., the frequency response of the sensor 120 is optimized for the frequency of the emitted beam 160.

System Operation

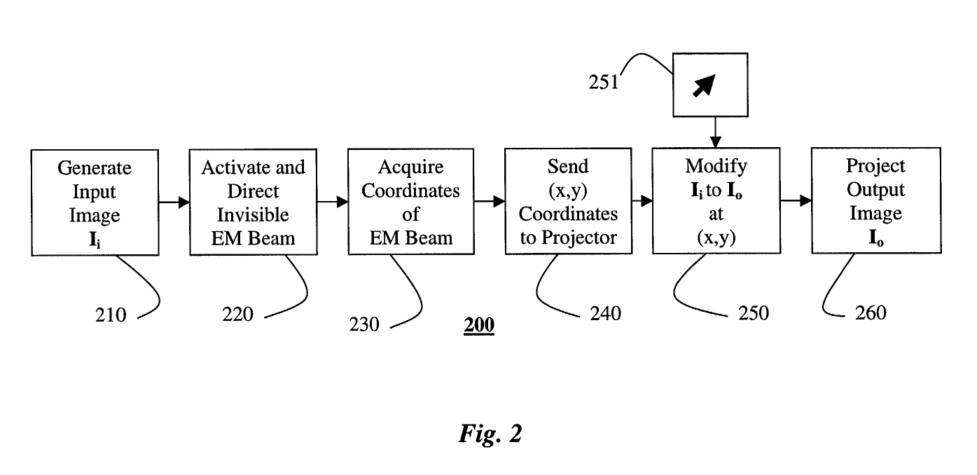

FIG. 2 shows a method 200 for operating the infrared laser pointer system 100. During operation of the method 200, the projector 130 generates 210 a visible input image (11) 131. It should be understood that images can be generated in a rapid sequence, as in a video. The image or images 131 can be generated within the projector 130, or the projector 130 can receive the images 131 from an external device 140, such as a computer system or camera.

The user of the system 100 activates 220 the invisible beam 160 with a switch 151 of the pointer 150, and roughly directs the invisible EM beam 160 at a desired location 170 on the display surface 110. Of course, the location 170 where the invisible beam 160 strikes the surface 110, in contrast with prior art optical laser pointers, is invisible to the naked eye, and does not need to be exact.

The sensor 120 acquires 230 the (x, y) coordinates 171 of the location 170 where the invisible EM beam 160 strikes the display surface 110. The coordinates 171 are sent 240 to the projector 130.

An image processor (IP) 132 modifies 250 the input image (Ii) 131 with an annotation 251 at the pixel coordinates (x, y) 171 corresponding to the location 170 to produce an output image (Iₒ) 133. For example, the annotation 251 can be a visible cursor “icon.” The output image 133 is then projected 260 onto the display screen 110.

As the beam 160 is directed at different locations of the display surface 110, the visible icon tracks the beam, without any observable delay, to the user of the pointer, and other viewers will perceive the annotation 251 as being emitted by the pointer 150.

System Features

The system 100 according to the invention has a number of features and advantages that are not found in prior art visible light pointer systems, these will now be enumerated.

The invisible EM beam 160, unlike prior art visible light beam pointers, does not need to be finely positioned or held steady. The image processor 132 can use hysteresis or some other type of filtering to dampen or remove jitter in the location of the beam. In addition, the size, shape and color of the annotation 251 can be independently selected by a slide or rotary switch 152.

Similar to a mouse/cursor pointing system, the system 100 according to the invention does not require calibration or exact pointing. In reality, like a mouse and cursor the pointing is indirect and the location of the cursor is relative to the location of the beam. In fact, the location 170 of the beam 160 does not even need to be coincident with the display surface 110. For example, the field of view of the sensor can span an area larger than the display screen. All that matters is that the sensed movement of the beam is relatively coupled to the movement of the annotation 251.

In another mode of operation, the switches 151 or 152 can be used to modulate the beam 160, and the sensor 120 can detect this modulation. Of course as before, the modulation is invisible to the human eye. Depending on the rate of the modulation, the user can indicate various commands to control the operation of the system 100, e.g., commands can include as “stop,” “forward,” “fast-forward,” “backward,” “enlarge,” “select,” etc.

Other techniques can be used to move the annotation 251 in the output image 131 in a predetermined pattern relative to the location 170, for example, cross-hairs, a circle or a square. Here again, the pattern can be user selected with the switches 151 or 152.

Either switch can be used to leave a “permanent” visible mark on the display surface 110. In other words, the output image 133 is annotated according to movement of the beam 160. For example, the user can underline text or draw an arbitrary figure on the display surface 110. Again, filtering techniques can be used to “fix-up” known shapes that the user draws, such as arrows, arcs, circles, and squares. In this mode, the pointer 150 can assume the same functions as a computer mouse, with drawing, clicking, selecting, erasing, etc, depending on detecting certain motions. For example, a rapid up-and-down motion can indicate “stop.”

The image processor 132 can also “remember” how an input image was annotated. Thus, if the user later returns to a previously annotated “slide,” the slide can be shown in the same form, without the user having to repeat the annotation.

The image processor 132 can also move, cut and paste portions of the output image according to movement of the beam, similar to the way a mouse “drags” an icon across a screen, or alters an image.

Although the invention has been described by way of examples of preferred embodiments, it is to be understood that various other adaptations and modifications can be made within the spirit and scope of the invention. Therefore, it is the object of the appended claims to cover all such variations and modifications.

I claim:

1. An invisible beam pointer system comprising:
a display surface;
a pointer configured for directing an invisible beam of electro-magnetic radiation at a location of the display surface; and
a sensor configured for acquiring coordinates of the location of the invisible beam of electro-magnetic radiation on the display surface.

2. The pointer system of claim 1 further comprising:
means for generating an input image; and
means for modifying the input image at pixels corresponding to the location to generate an output image.

3. The pointer system of claim 2 further comprising:
means for projecting the output image onto the display surface.

4. The pointer system of claim 1 wherein a wavelength of the electro-magnetic radiation is greater than approximately 700 nanometers.

5. The pointer system of claim 1 wherein a wavelength of the electro-magnetic radiation is less than approximately 400 nm.

6. The pointer system of claim 3 wherein the modification is a displayable icon.

7. The pointer system of claim 2 wherein the input and output images are a video.

8. The pointer system of claim 1 further comprising:
means for damping motion of the sensed location of the invisible beam of electro-magnetic radiation on the display surface.

9. The pointer system of claim 2 further comprising:
means for adjusting a size, color and shape of the icon.

10. The pointer system of claim 2 wherein a movement of the icon in the output image is relative to a movement of the invisible beam of electro-magnetic radiation on the display surface.

11. The pointer system of claim 2 wherein the means for generating the input image is a computer system.

12. The pointer system of claim 1 further comprising:
means for generating an input image; and
means for modifying the input image at pixels corresponding to the location to generate an output image; and
means for modulating the invisible beam of electro-magnetic radiation to control the modification of the input image.

13. The pointer system of claim 6 wherein the icon is moved according to a predetermined pattern.

14. The pointer system of claim 12 wherein the modification is persistent.

15. A method for pointing at a display surface, comprising:
directing an invisible beam of electro-magnetic radiation at a location of the display surface; and
sensing coordinates of the location of the invisible beam of electro-magnetic radiation on the display surface.

16. The method of claim 15 further comprising:
generating an input image; and
modifying the input image at pixels corresponding to the location to generate an output image.

17. The method of claim 16 further comprising:
projecting the output image onto the display surface.

18. The method of claim 15 further comprising:
modulating the invisible beam of electro-magnetic radiation on the display surface.

19. The method of claim 15 further comprising:
damping motion of the sensed location of the invisible beam of electro-magnetic radiation on the display surface.

20. An invisible beam pointer system comprising:
a display surface;
a pointer configured for directing an invisible beam of electro-magnetic radiation at a location of the display surface; and
a sensor configured for acquiring coordinates of the location of the invisible beam of electro-magnetic radiation on the display surface.
means for generating an input image; and
means for modifying the input image at pixels corresponding to the location to generate an output image; and
means for projecting the output image onto the display surface.
